(19) United States
(12) Patent Application Publication
(10) Pub. No.: US 2017/0072968 A1
(43) Pub. Date: Mar. 16, 2017

(54) OPERATION SYSTEM FOR VEHICLE

(71) Applicant: Yazaki Corporation, Tokyo (JP)

(72) Inventor: Takashi Azuchi, Shizuoka (JP)

(21) Appl. No.: 15/259,806

(22) Filed: Sep. 8, 2016

(30) Foreign Application Priority Data
Sep. 14, 2015 (JP) 2015-180371

(51) Int. Cl. B60W 50/08

(52) U.S. Cl. CPC B60W 50/08; B60W 2420/40

(57) ABSTRACT

An operation system for vehicle includes a longitudinal member, a movement detector, and a controller. The movement detector is provided to a tip of the longitudinal member and detects, in a sensing space set so as not to detect movement of hands or fingers of an operator who holds a steering wheel without intention of operating an in-vehicle device, an operation form when the operator operates the in-vehicle device. The controller transmits a command to the in-vehicle device based on an output signal of the movement detector. The movement detector includes a sensor having a light-emitting unit and a light-receiving unit, and a housing. The housing includes a non-transmission part and a transmission part that transmits light so that the light forms the sensing space.

### CROSS-REFERENCE TO RELATED APPLICATION(S)

The present application claims priority to and incorporates by reference the entire contents of Japanese Patent Application No. 2015-180371 filed in Japan on Sep. 14, 2015.

### BACKGROUND OF THE INVENTION

1. Field of the Invention

The present invention relates to an operation system for vehicle.

2. Description of the Related Art

An operation system for vehicle is a system for causing an operator to operate an in-vehicle device mounted on a vehicle. For example, there has been known an operation system for vehicle that includes a lever operating unit provided to a steering column and a detector provided to the tip of the lever operating unit for detecting movement of hands or fingers, and that allows an operator to operate without releasing his/her hands from a steering wheel (for example, Japanese Patent Application Laid-open No. 2014-144693).

In this kind of operation system for vehicle, there is an operation system for vehicle that detects movement of hands or fingers in a non-contact manner, and in this case, has a sensing space capable of detecting the movement. However, this operation system for vehicle detects movement of hands or fingers with a tip side of a lever operating unit, and may detect, when the sensing space is present over an excessively wide range, movement of hands or fingers of an operator who does not have the operational intention. When the movement matches an operation form for an in-vehicle device, the operation system for vehicle may cause the in-vehicle device to malfunction.

### SUMMARY OF THE INVENTION

An object of the present invention is to provide an operation system for vehicle capable of reducing occurrence of malfunction.

In order to achieve the above mentioned object, an operation system for vehicle according to one aspect of the present invention includes a longitudinal member that is projected and extended from a steering column; a movement detector that is provided to a tip of the longitudinal member in a projecting direction, and is capable of detecting, in a sensing space within a predetermined range from the tip set so as not to detect movement of hands or fingers of an operator who holds a steering wheel without intention of operating an in-vehicle device, an operation form of the operator when the operator operates the in-vehicle device; and a controller configured to transmit a command to the in-vehicle device based on an output signal of the movement detector depending on the operation form of the operator, wherein the movement detector includes a sensor having a light-emitting unit and a light-receiving unit and a housing that accommodates the sensor, and the housing includes a non-transmission part that does not transmit the light, and a transmission part that transmits the light emitted from the sensor so that the light forms the sensing space.

According to another aspect of the present invention, in the operation system for vehicle, it is preferable that the light-emitting unit is configured to emit the light in the projecting direction with an effective emitting distance and at an effective emitting angle, and the transmission part is disposed on a tip surface of the housing in the projecting direction and is a narrowing unit configured to narrow a transmission range of the light on the tip surface.

According to still another aspect of the present invention, in the operation system for vehicle, it is preferable that at least one set of a combination of the longitudinal member with the movement detector is provided to at least one of the left end and the right end of the steering column in a vehicle width direction.

According to still another aspect of the present invention, it is preferable that the operation system for vehicle further includes a main operation device that is provided with a lever operating unit including the longitudinal member and a lever operating detector configured to detect tilting direction of tilting operation using an end part of the longitudinal member on the steering column side as a fulcrum, and operates the in-vehicle device or an in-vehicle device other than the in-vehicle device that is assigned to a tilting direction of the tilting operation as an operation direction of the longitudinal member; and a sub-operation device that includes the movement detector.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a front view illustrating the configuration of an operation system for vehicle according to an embodiment;

FIG. 2 is a top view illustrating the configuration of the operation system for vehicle according to the embodiment;

FIG. 3 is a perspective view illustrating the configuration of a main operation device and a sub-operation device according to the embodiment;

FIG. 4 is a cross-sectional view illustrating the main operation device and the sub-operation device cut along line X-X of FIG. 3;

FIG. 5 is a perspective view illustrating the internal configuration of the sub-operation device;

FIG. 6 is a view illustrating an example of an operation form with respect to the sub-operation device;

FIG. 7 is a view illustrating another example of an operation form with respect to the sub-operation device;

FIG. 8 is a cross-sectional view illustrating the configuration of a modification of the sub-operation device according to the embodiment;

FIG. 9 is a cross-sectional view illustrating the configuration of a modification of the sub-operation device according to the embodiment; and

FIG. 10 is a cross-sectional view illustrating an emission range of a sensor and a sensing space going through a transmission part.

### DETAILED DESCRIPTION OF THE PREFERRED EMBODIMENTS

An embodiment of an operation system for vehicle according to the present invention will now be described with reference to the accompanying drawing. It should be noted that the embodiment below is not intended to limit the invention.

### Embodiment

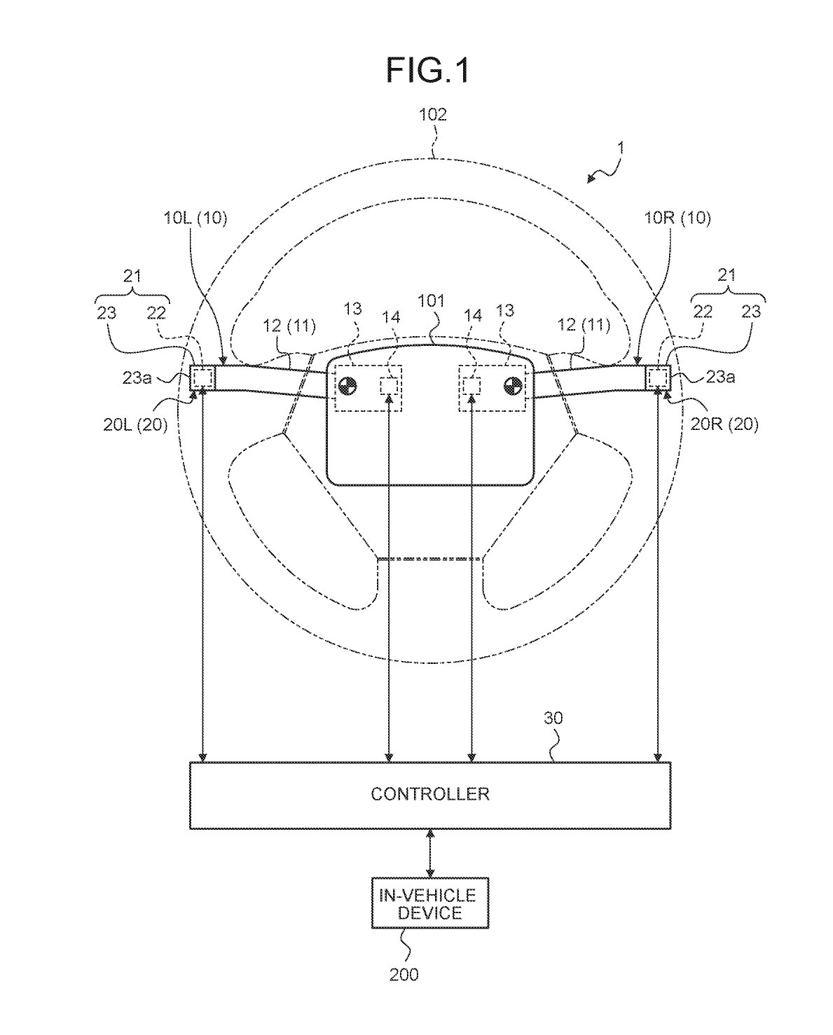

One of the embodiments of an operation system for vehicle according to the present invention will now be described with reference to FIGS. 1 to 10.

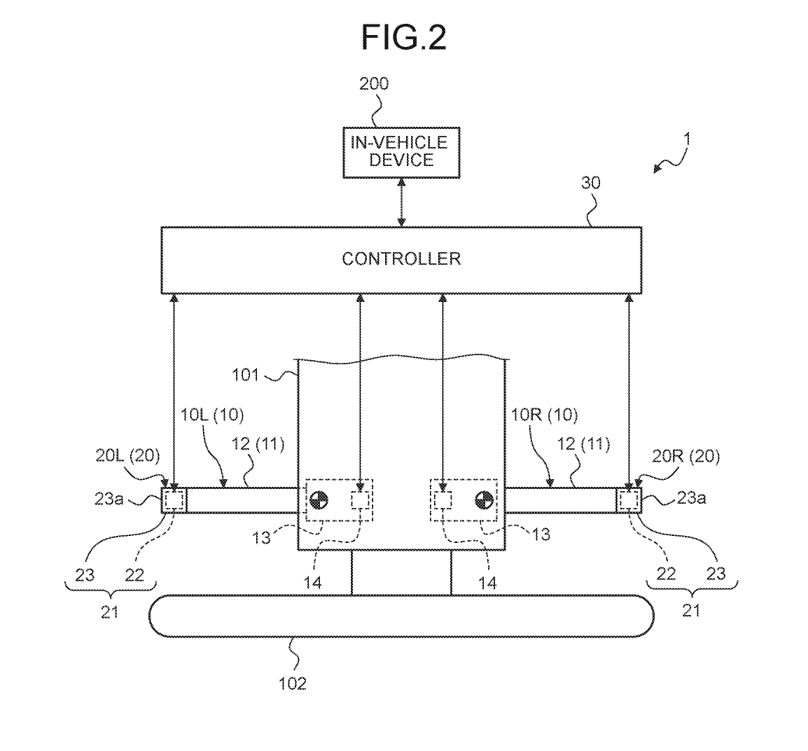

The operation system for vehicle according to the present embodiment has a configuration to allow an operator (driver) to operate an in-vehicle device mounted on a vehicle without releasing his/her hands from a steering wheel. Reference numeral 1 in FIGS. 1 and 2 indicates the operation system for vehicle in such a configuration.

This operation system for vehicle 1 in the embodiment is disposed on a steering column 101 (in other words, a back side of a steering wheel 102 (front side of a vehicle with respect to the steering wheel 102)) in a vehicle compartment. The operation system for vehicle 1 includes a main operation device 10 and a sub-operation device 20 for operating an in-vehicle device 200, and a controller 30. In this operation system for vehicle 1, at least one set of a combination of the main operation device 10 with the sub-operation device 20 is provided to at least one of the left end and the right end of the steering column 101 in a vehicle width direction. The example in FIG. 1 illustrates one set of a combination of a main operation device 10L with a sub-operation device 20L provided to the left end of the steering column 101, and one set of a combination of a main operation device 10R with a sub-operation device 20R provided to the right end of the steering column 101.

The in-vehicle device 200 has at least one function (working forms) performed in association with operation of the operation system for vehicle 1 performed by an operator. Examples of the in-vehicle device 200 include lamp devices of a vehicle (head lamps and tail lamps), a direction indicator, and a wiper. When the in-vehicle device 200 is mounted in a vehicle compartment, examples of the in-vehicle device 200 include sound equipment such as audio devices and radios and an air conditioning machine (what is called an air conditioner). In addition, examples of the in-vehicle device 200 include devices that are not mounted in a vehicle itself, but are brought in a vehicle compartment so as to be mounted in a vehicle (for example, a cellular telephone and a portable music player).

Hereinafter, unless specifically mentioned, a direction along a rotation axis of the steering wheel 102 is referred to as an axis direction, and a direction around the rotation axis is referred to as a circumferential direction. Moreover, a direction perpendicular to the rotation axis is referred to as a radial direction.

The main operation device 10 includes a lever operating unit 11. This lever operating unit 11 includes a longitudinal member 12 projecting and extending from the steering column 101. The main operation device 10 is what is called a lever switch for operating the in-vehicle device 200 assigned to an operation direction of the longitudinal member 12.

The longitudinal member 12 includes, for example, a cylindrical main part, and this main part projects from the steering column 101 in a certain direction. Examples of the certain direction include a radial direction, a right obliquely upward direction to the right side and the upper side of a vehicle, a right obliquely downward direction to the right side and the lower side of a vehicle, a left obliquely upward direction to the left side and the upper side of a vehicle, a left obliquely downward direction to the left side and the lower side of a vehicle, and a direction tilted to the rear side of a vehicle in each of these directions using an end part on a steering column 101 side as a fulcrum. The main part of the longitudinal member 12 may be formed in a straight shape, and may be provided with a bent portion in the middle of a path. An end part of this longitudinal member 12 in a projection direction extends to a position where an operator holding a left end part or a vicinity of the left end part, or a right end part or a vicinity of the right end part of the steering wheel 102 in a vehicle width direction can touch the longitudinal member 12 with his/her hands and fingers. In this manner, an operator can touch the tip of the longitudinal member 12 in a projection direction with his/her hands and fingers (for example, a middle finger and a forefinger) while holding the steering wheel 102.

This longitudinal member 12 is tiltably supported by a supporting unit 13 fixed to an inner part of the steering column 101. The supporting unit 13 is configured to allow free tilting operation using an end part of the longitudinal member 12 on a steering column 101 side as a fulcrum. In the lever operating unit 11, a tilting direction of the longitudinal member 12 in tilting movement is an operation direction by an operator with respect to the longitudinal member 12. This exemplified longitudinal member 12 can perform tilting movement for the front side of a vehicle, tilting movement for the rear side of a vehicle, clockwise tilting movement for one circumferential direction, counterclockwise tilting movement for the other circumferential direction from a neutral position as a reference point. At least one in-vehicle device 200 and at least one function of the in-vehicle device 200 are assigned to each of the operation directions of this longitudinal member 12.

The supporting unit 13 may cause the longitudinal member 12 to be returned to the neutral position using a spring force and the like after tilting the longitudinal member 12 from a neutral position to a certain operation direction, and may cause the longitudinal member 12 to be returned to the neutral position with hands of an operator after tilting the longitudinal member 12 from the neutral position to a certain operation direction. In the latter case, the supporting unit 13 allows the longitudinal member 12 to perform at least one step of tilting operation.

The main operation device 10 is provided with a lever operation detector 14 that detects the tilting direction in the tilting operation of the longitudinal member 12. This lever operation detector 14 transmits an output signal depending on the tilting direction of the longitudinal member 12 to the controller 30. The controller 30 can detect the operation direction of the longitudinal member 12 performed by an operator based on the output signal.

The controller 30 transmits a command (a drive command or a stop command) to the in-vehicle device 200 based on the output single of the lever operation detector 14, and drives or stops a function of the in-vehicle device 200 depending on operation to the longitudinal member 12 performed by an operator. The command to the in-vehicle device 200 may be a command for directly driving or stopping the in-vehicle device 200, and may be a command to a controller of the in-vehicle device 200. When receiving a command from the controller 30, the controller in the in-vehicle device 200 drives or stops a function of the in-vehicle device 200 based on contents of the command.

The sub-operation device 20 is a switch for operating another function of the in-vehicle device 200 the same as the operation object of the main operation device 10 or another in-vehicle device 200 different from the operation object of the main operation device 10. This sub-operation device 20 defines a plurality of operation forms for operating the in-vehicle device 200. Each operation form is to express operational intentions of an operator for the in-vehicle device 200. At least one in-vehicle device 200 and at least one function of the in-vehicle device 200 are assigned to each operation form.

This sub-operation device 20 is provided to the tip of the longitudinal member 12 in the projection direction, and includes a movement detector 21 capable of detecting the operation form when an operator operates the in-vehicle device 200. The operation form is defined depending on the sub-operation device 20, and is, for example, movement of hands and fingers corresponding to an operational intention of an operator. Thus, the movement detector 21 is disposed at a position where an operator holding the steering wheel 102 simply stretches his/her hands or fingers so as to reach the movement detector 21.

The controller 30 transmits a command (a drive command or a stop command) to the in-vehicle device 200 based on an output signal of the movement detector 21 depending on an operation form of an operator, and drives or stops a function of the in-vehicle device 200 depending on operation form of the operator. The command to the in-vehicle device 200 is the same as the one exemplified as above.

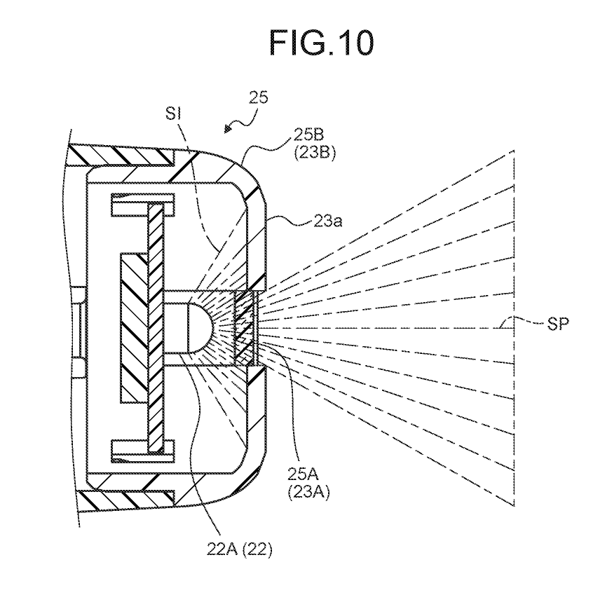

The movement detector 21 in the embodiment is configured to be capable of detecting an operation form of an operator in a non-contact manner at a sensing space SP (for example, FIG. 10, which will be described later) using the tip of the longitudinal member 12 as a base point (in other words, within a predetermined range from the tip). The sensing space SP is, for example, a space extending at least from the tip of a tip part of the longitudinal member 12 to a vehicle side part along an axis direction of the tip part. The sensing space SP is set so as not to detect movement of hands or fingers of an operator who does not have the intention of operating the in-vehicle device 200 and holds a steering wheel (that includes not only a state where the operator holds the steering wheel 102 but also a state where the operator performs steering operation while holding the steering wheel 102 (what is called a steering-held operation state)).

The movement detector 21 includes a non-contact sensor 22 capable of detecting an object present in the sensing space SP and a moving direction of the object in the sensing space SP, and a housing 23 that accommodates the non-contact sensor 22. For example, a sensor including a light-emitting unit and a light-receiving unit (what is called a light sensor) can be used for the non-contact sensor 22. The non-contact sensor 22 is provided with a combination of an emitting unit and a light-receiving unit depending on an operation form to be detected. The housing 23 is formed in a cylindrical shape with a tip side closed, and includes a transmission part that transmits light emitted from the emitting unit of the non-contact sensor 22 so that the light forms the sensing space SP, and a non-transmission part that does not transmit light. Thus, even when an operator holding a steering wheel moves hands or fingers without the intention of operating the in-vehicle device 200, for example, changes a position of the steering wheel 102 to be held, the movement detector 21 is unlikely to detect movement of the hands or fingers. In this manner, the operation system for vehicle 1 can reduce occurrence of malfunction of the in-vehicle device 200 in association with the movement of hands or fingers of an operation who does not have the operational intention. The emitting unit of the non-contact sensor 22 emits light in the projecting direction of the longitudinal member 12 with an effective emitting distance and at an effective emitting angle. Therefore, the transmission part is disposed on a tip surface 23a of the housing 23 in the projecting direction. The transmission part functions as a narrowing unit that narrows a transmission range of light on the tip surface 23a.

The following describes a specific example.

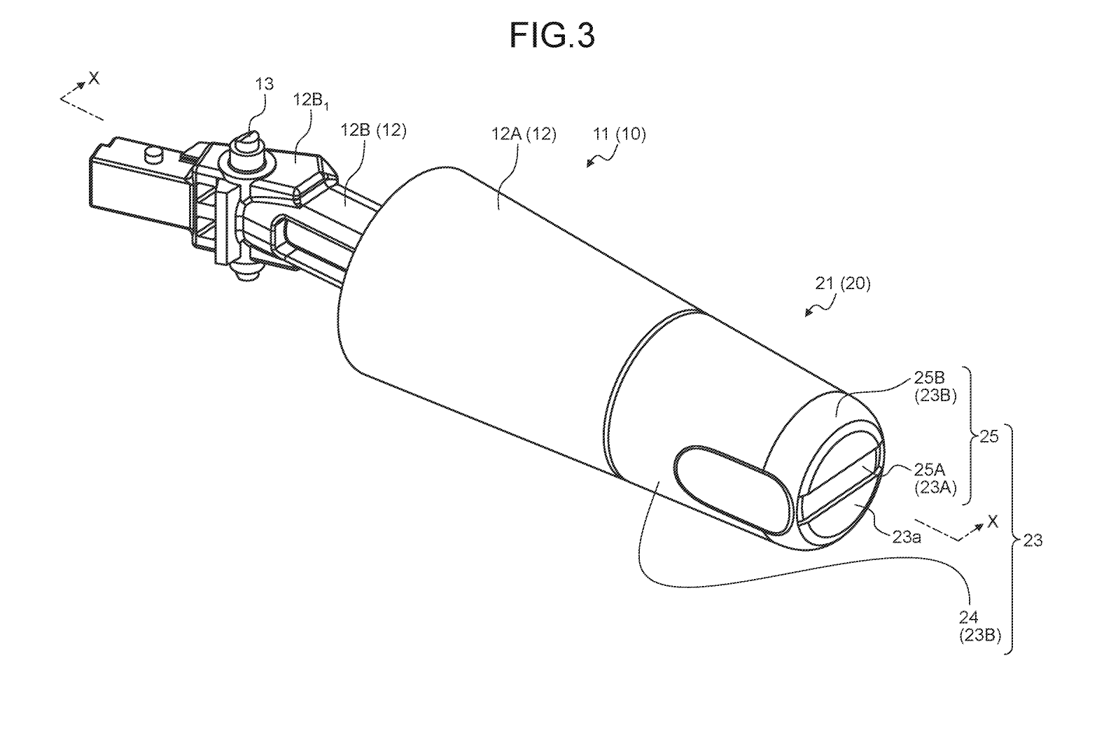

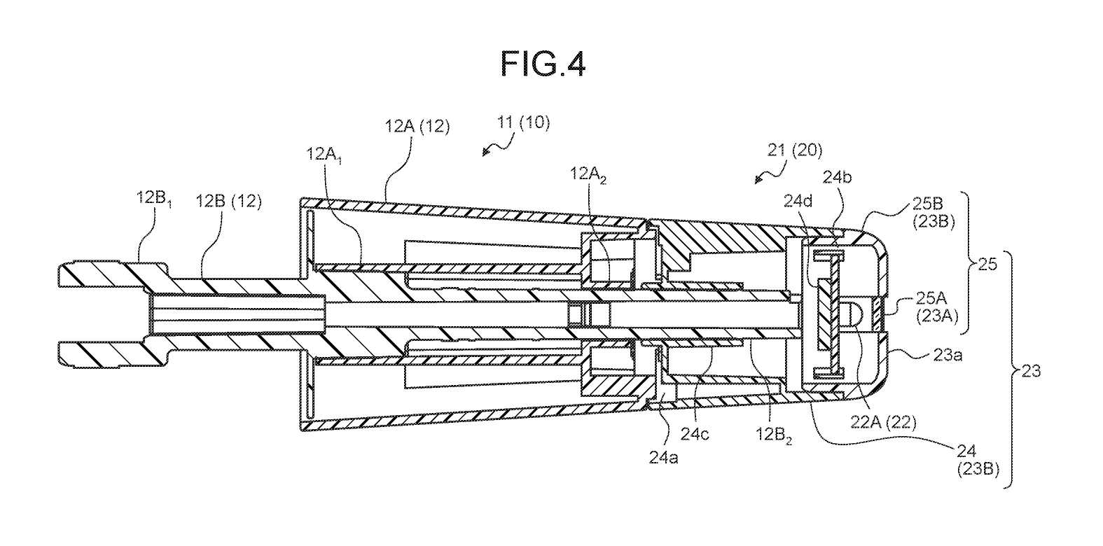

The lever operating unit 11 in the exemplified main operation device 10 includes a cylindrical member 12A formed in a truncated cone cylindrical shape and an axis member 12B disposed inside the cylindrical member 12A and on a central axis of the cylindrical member 12A as the longitudinal member 12 (FIGS. 3 and 4). The cylindrical member 12A includes therein first and second engagement units 12A₁ and 12A₂ that are engaged with the axis member 12B, and is held by the axis member 12B through the first and second engagement units 12A₁ and 12A₂. This cylindrical member 12A is formed of a synthetic resin material. The axis member 12B projects from apertures on both ends of the cylindrical member 12A in the axis direction, and one end 12B₁ is connected to the supporting unit 13.

In this exemplified sub-operation device 20, the housing 23 of the movement detector 21 also serves as a housing of the sub-operation device 20 itself. This housing 23 includes a case 24 and a lid 25.

The case 24 is made of a cylindrical member formed in a truncated cone cylindrical shape arranged continuously with the cylindrical member 12A of the lever operating unit 11. In this case 24, an aperture 24a on one end in an axis direction of the case 24 is closed by the cylindrical member 12A, and an aperture 24b on the other end is closed by the lid 25. This case 24 includes therein an engagement unit 24c that is engaged with the other end 12B₂ of the axis member 12B, and is held by the other end 12B₂ of the axis member 12B through the engagement unit 24c. The non-contact sensor 22 is disposed on the aperture 24b on the other end of this case 24. Thus, the case 24 is provided with a holding unit 24d for the non-contact sensor 22 inside the other end side.

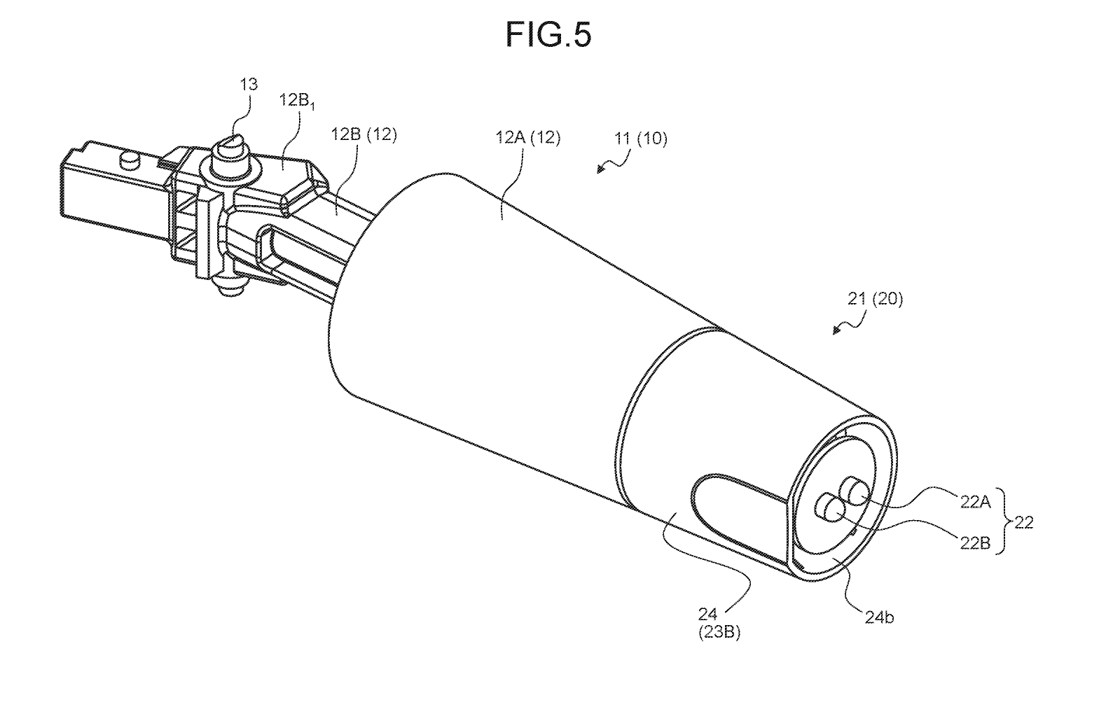

A near-infrared sensor is used for this exemplified non-contact sensor 22. This non-contact sensor 22 includes at least one light-emitting unit (emitting unit) 22A that has a light-emitting diode and emits near-infrared light and one light-receiving unit 22B that has a photodiode and receives near-infrared light (FIG. 5). Moreover, the non-contact sensor 22 includes a signal processing unit (not illustrated) that performs signal processing related to the light-emitting unit 22A and the light-receiving unit 22B. The non-contact sensor 22 can perceive an operation form of an operator in the sensing space SP based on near-infrared light (modulated light) in the sensing space SP that is formed by emission of the light-emitting unit 22A and reflected light of the near-infrared light that is received by the light-receiving unit 22B.

The lid 25 is engaged with the other end of the case 24. In this lid 25, an end surface in the axis direction and the projecting direction of the case 24 serves as the tip face 23a of the housing 23.

In this housing 23, the case 24 may be engaged with and fixed to the axis member 12B, and may be engaged with the axis member 12B so that relative rotation in a circumferential direction can be performed around the axis member 12B. In the latter case, this case 24 is used as a rotation operating unit that assigns a function of the in-vehicle device 200 to the relative rotation.

This housing 23 includes a transmission part 23A that transmits near-infrared light emitted from the light-emitting unit (emitting unit) 22A of the non-contact sensor 22 so that the near-infrared light forms the sensing space SP, and a non-transmission part 23B that does not transmit near-infrared light. In this housing 23, a part of the lid 25 is the transmission part 23A, and the case 24 and the remaining part of the lid 25 are the non-transmission part 23B. In the movement detector 21, the transmission part 23A narrows a transmission range of near-infrared light that is emitted in a truncated cone shape with an effective emitting distance and at an effective emitting angle from the light-emitting unit (emitting unit) 22A so as to form a desirable sensing space SP defined as a design value. A shape of the transmission part 23A and a position of the transmission part 23A with respect to an arrangement place of the non-contact sensor 22 are determined depending on a shape of the desirable sensing space SP. This exemplified transmission part 23A is formed in a rectangular shape that equally divides the round tip surface 23a into two, but the shape is not necessarily limited to the rectangular shape. For example, the shape of the transmission unit 23A may be a round shape having a diameter smaller than that of the tip surface 23a and concentric to the tip surface 23a.

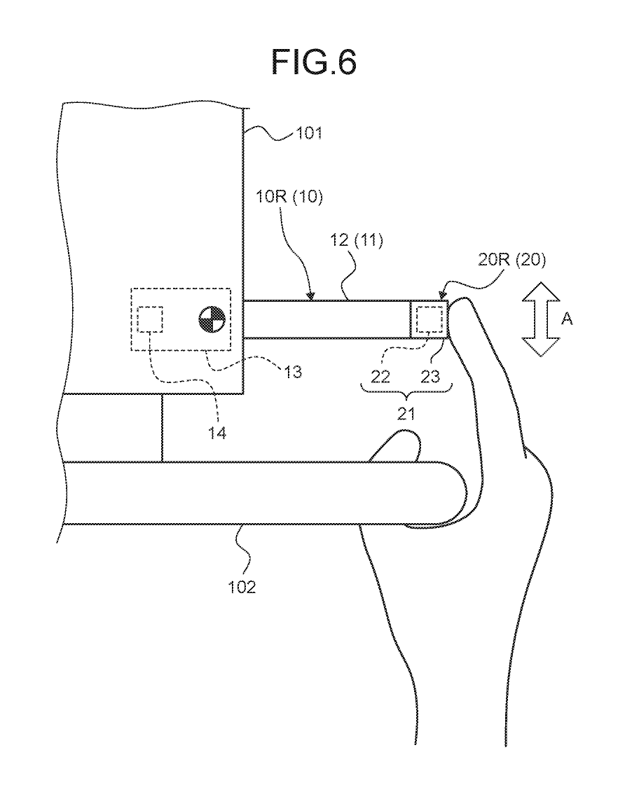

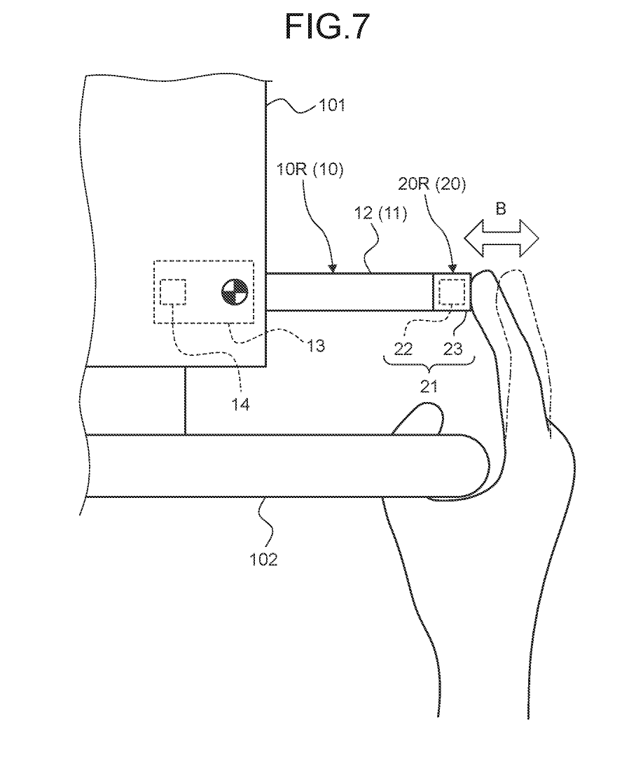

In this exemplified movement detector 21, for example, a longitudinal direction of the rectangular-shaped transmission part 23A in the sensing space SP is assigned as an operation direction of hands and fingers of an operator (direction of an arrow A in FIG. 6). This operation mainly includes non-contact operation performed when hands or fingers do not contact the transmission part 23A, and slide operation (contact operation) performed while hands or fingers contact the transmission part 23A. In the movement detector 21, the non-contact sensor 22 and the transmission part 23A are disposed so as to detect such an operation form. Selecting operation functions such as device selecting operation for selecting a desirable one from a plurality of in-vehicle devices 200, function selecting operation for selecting a desirable one from a plurality of functions that the in-vehicle device 200 has, and condition selecting operation for selecting a desirable one from a plurality of selecting conditions that a certain function has can be assigned to this operation. The function selecting operation is, for example, operation for selecting, when the in-vehicle device 200 is sound equipment, a desirable function among a media selecting function, a sound volume selecting function, a track selecting function, and the like. The condition selecting operation is operation for selecting, for example, when a sound volume selecting function is selected, desirable sound volume. In this manner, this exemplified movement detector 21 can detect contact operation of hands and fingers to the transmission part 23A, and can also detect touch operation in a direction of an arrow B in FIG. 7. For example, a determination operating function performed when a function and a selecting condition selected by operation along a longitudinal direction of the transmission part 23A are determined, a return operating function for instantly returning selecting operation in the last hierarchy and selecting operation on the first layer, and the like can be assigned to this touch operation. As this touch operation, a single touch operation and a plurality of repeated pressing operations can be defined.

In this housing 23, for example, a part serving as the transmission part 23A is formed of a synthetic resin material (hereinafter, referred to as a “light transmission material”) capable of transmitting near-infrared light, and a part serving as the non-transmission part 23B is formed of a synthetic resin material (hereinafter, referred to as a “non-light transmission material”) incapable of transmitting near-infrared light. The light transmission material has a high light transmission property, and examples of the light transmission material include an acrylic resin (such as polymethyl methacrylate (PMMA) resin) and polycarbonate. Examples of the non-light transmission material include an acrylonitrile butadiene styrene (ABS) resin having a low light transmission property. In this case, the case 24 is formed of the non-light transmission material. The lid 25 has a transmission area 25A serving as the transmission part 23A and a non-transmission area 25B serving as the non-transmission part 23B mixed. Thus, the lid 25 may be formed by, for example, two-color molding of a light transmission material and a non-light transmission material, and may be formed by individually molding a member that forms the transmission area 25A and a member that forms the non-transmission area 25B and integrating these members by engagement and the like. In this exemplified lid 25, a U-shaped member formed of a light transmission material having the transmission area 25A and a main member serving as the non-transmission area 25B with a non-light transmission material are formed by two-color molding.

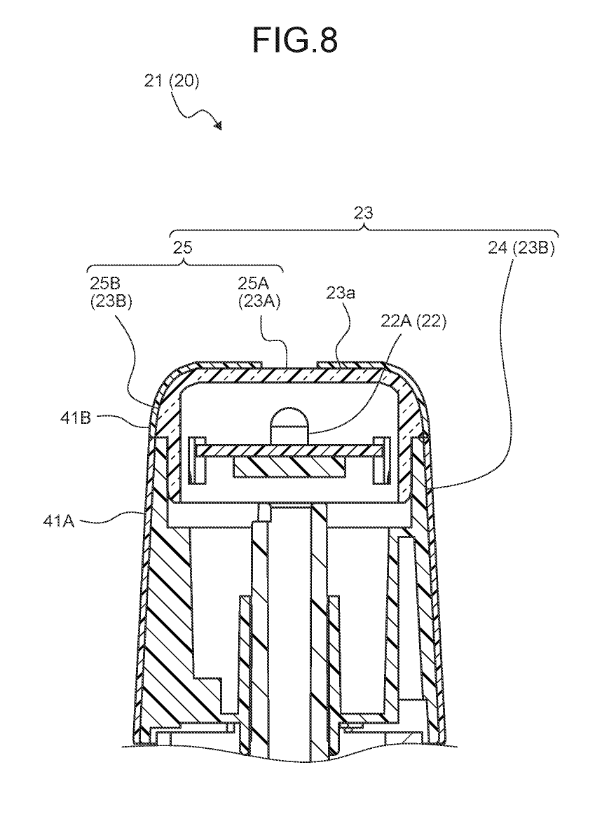

In the housing 23, the case 24 and the lid 25 may be formed of light transmission material. In this case, in the housing 23, the transmission part 23A and the non-transmission part 23B can be formed by applying a non-light transmissive coating material incapable of transmitting near-infrared light to the non-transmission area 25B in the case 24 and the lid 25. In the case 24, the non-light transmissive coating material is applied to at least one of the outer wall surface and the inner wall surface. By contrast, in the lid 25, the non-light transmissive coating material is applied to at least one of the outer wall surface and the inner wall surface of a part serving as the non-transmission area 25B so as to form the transmission area 25A. FIG. 8 illustrates one example where non-light transmissive coating materials 41A and 41B are applied to the outer wall surfaces of the case 24 and the lid 25, respectively. In the lid 25, the non-light transmissive coating material 41B is applied to the outer wall surface except for a part engaged with the case 24.

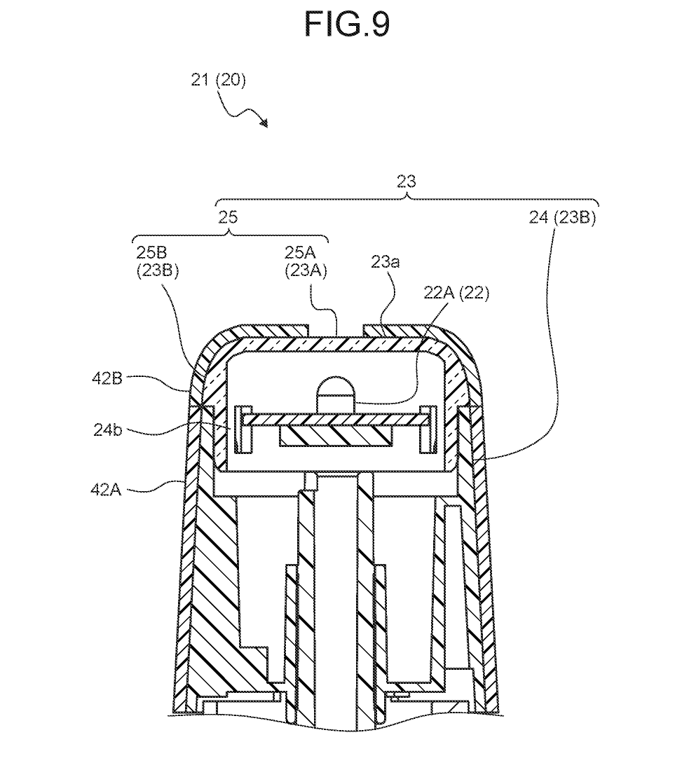

When the case 24 and the lid 25 are formed of light transmission material, the non-transmission area 25B may be provided with a non-light transmissive member in place of a non-light transmissive coating material. The non-light transmissive member is a member formed of a non-light transmission material. The case 24 is provided with a non-light transmissive member formed in a truncated cone cylindrical shape on at least one of the outer peripheral surface and the inner peripheral surface. This exemplified case 24 is provided with the engagement unit 24c and the holding unit 24d arranged continuously with the inner peripheral surface thereof, and the whole inner peripheral surface is hardly covered with the outer peripheral surface of the non-light transmissive member formed in a truncated cone cylindrical shape. Thus, in the exemplified case 24, only the inner peripheral surface on the other end side rather than the holding unit 24d is covered with the outer peripheral surface of the non-light transmissive member formed in a truncated cone cylindrical shape, and, as illustrated in FIG. 9, the whole outer peripheral surface is desirably covered with the inner peripheral surface of a non-light transmissive member 42A formed in a truncated cone cylindrical shape. In the example in FIG. 9, for example, the case 24 is inserted inside the non-light transmissive member 42A from the aperture 24b side on the other end, and the case 24 and the non-light transmissive member 42A are engaged with each other. By contrast, in the lid 25, a non-light transmissive member is provided to at least one of the outer peripheral surface and the inner peripheral surface of a part serving as the non-transmission area 25B so as to form the transmission area 25A. FIG. 9 illustrates one example where a non-light transmissive member 42B is provided to an outer wall surface side of a part serving as the non-transmission area 25B of the lid 25. The non-light transmissive member 42B covers an outer wall surface except for a part engaged with the case 24 in the lid 25, and is engaged with the outer wall surface.

As described above, in the operation system for vehicle 1 according to the embodiment, the housing 23 in the movement detector 21 of the sub-operation device 20 is provided with the transmission part 23A formed in order to form a desirable sensing space SP (sensing space SP set so as not to detect movement of hands or fingers of an operator who does not have the intention of operating the in-vehicle device 200 and holds a steering wheel). Thus, in the movement detector 21, light emitted from the non-contact sensor 22 with an effective emitting distance and at an effective emitting angle goes through the transmission part 23A, and is emitted in a range narrower than an emission range SI so as to form the desirable sensing space SP (FIG. 10). In this manner, in the operation system for vehicle 1, when an operator moves hands or fingers without the intention of operating the in-vehicle device 200, the movement detector 21 hardly detects the movement of the hands or the fingers so as to reduce occurrence of malfunction of the in-vehicle device 200 in association with the movement of hands or fingers of an operator who does not have the operational intention.

In addition, the operation system for vehicle 1 according to the embodiment, the housing 23 of the movement detector 21 is formed to transmit light only from the transmission part 23A, and the light-receiving unit 22B of the non-contact sensor 22 hardly receives unnecessary light such as disturbance light. In this manner, this operation system for vehicle 1 can reduce occurrence of malfunction of the in-vehicle device 200 in association with input of such unnecessary light, and can reduce, from this point, occurrence of malfunction of the in-vehicle device 200 in association with the movement of hands or fingers of an operator who does not have the operational intention.

In the examples described above, the sub-operation device 20 is provided to the tip of the longitudinal member 12 in the projecting direction capable of performing tilting operation in the main operation device 10. However, the movement detector 21 of the sub-operation device 20 may be provided to the tip of the fixed longitudinal member 12 where movement such as tilting operation with respect to the steering column 101 is prohibited. The fixed longitudinal member 12 is a long object that projects and extends from the steering column 101, and one end thereof is fixed to the inside of the steering column 101. At least one set of a combination of the fixed longitudinal member 12 with the movement detector 21 is provided to at least one of the left end and the right end of the steering column 101 in a vehicle width direction. This combination may be disposed in place of the combination of the main operation device 10 with the sub-operation device 20 exemplified above, and may be disposed together with the combination of the main operation device 10 with the sub-operation device 20.

In an operation system for vehicle according to the present invention, light emitted from a sensor goes through a transmission part, and the light is emitted in a range narrower than the emission range of the sensor so as to form a desirable sensing space (sensing space set so as not to detect movement of hands or fingers of an operator who holds a steering wheel without intention of operating an in-vehicle device). In the operation system for vehicle, when an operator moves hands or fingers without the intention of operating an in-vehicle device, a movement detector is unlikely to detect the movement of hands or fingers so as to reduce occurrence of malfunction of the in-vehicle device in association with the movement of hands or fingers of an operator who does not have the operational intention.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An operation system for vehicle comprising:
a longitudinal member that is projected and extended from a steering column;
a movement detector that is provided to a tip of the longitudinal member in a projecting direction, and is capable of detecting, in a sensing space within a predetermined range from the tip set so as not to detect movement of hands or fingers of an operator who holds a steering wheel without intention of operating an in-vehicle device, an operation form of the operator when the operator operates the in-vehicle device; and
a controller configured to transmit a command to the in-vehicle device based on an output signal of the movement detector depending on the operation form of the operator, wherein
the movement detector includes a sensor having a light-emitting unit and a light-receiving unit and a housing that accommodates the sensor, and
the housing includes a non-transmission part that does not transmit the light, and a transmission part that transmits the light emitted from the sensor so that the light forms the sensing space.

2. The operation system for vehicle according to claim 1, wherein
the light-emitting unit is configured to emit the light in the projecting direction with an effective emitting distance and at an effective emitting angle, and
the transmission part is disposed on a tip surface of the housing in the projecting direction and is a narrowing unit configured to narrow a transmission range of the light on the tip surface.

3. The operation system for vehicle according to claim 1, wherein
at least one set of a combination of the longitudinal member with the movement detector is provided to at least one of the left end and the right end of the steering column in a vehicle width direction.

4. The operation system for vehicle according to claim 2, wherein
at least one set of a combination of the longitudinal member with the movement detector is provided to at least one of the left end and the right end of the steering column in a vehicle width direction.

5. The operation system for vehicle according to claim 1, further comprising:
a main operation device that is provided with a lever operating unit including the longitudinal member and a lever operating detector configured to detect tilting direction of tilting operation using an end part of the longitudinal member on the steering column side as a fulcrum, and operates the in-vehicle device or an in-vehicle device other than the in-vehicle device that is assigned to a tilting direction of the tilting operation as an operation direction of the longitudinal member; and
a sub-operation device that includes the movement detector.

6. The operation system for vehicle according to claim 2, further comprising:
a main operation device that is provided with a lever operating unit including the longitudinal member and a lever operating detector configured to detect tilting direction of tilting operation using an end part of the longitudinal member on the steering column side as a fulcrum, and operates the in-vehicle device or an in-vehicle device other than the in-vehicle device that is assigned to a tilting direction of the tilting operation as an operation direction of the longitudinal member; and
a sub-operation device that includes the movement detector.

7. The operation system for vehicle according to claim 3, further comprising:
a main operation device that is provided with a lever operating unit including the longitudinal member and a lever operating detector configured to detect tilting direction of tilting operation using an end part of the longitudinal member on the steering column side as a fulcrum, and operates the in-vehicle device or an in-vehicle device other than the in-vehicle device that is assigned to a tilting direction of the tilting operation as an operation direction of the longitudinal member; and
a sub-operation device that includes the movement detector.
